(19) United States
(12) Patent Application Publication
(10) Pub. No.: US 2026/0284682 A1
(43) Pub. Date: Sep. 24, 2026

(54) SPRAY APPLICATOR AND SPRAY SYSTEM

(71) Applicant: PPG Industries Ohio, Inc., Cleveland, OH (US)

(72) Inventors: Chinming Hui, Pittsburgh, PA (US); Patricia Olivia Trevino Suarez del Real, Pittsburgh, PA (US); Mengqiao Yang, Gibsonia, PA (US); Xiaohai Jiang, Gibsonia, PA (US); Wells Benjamin Warren, III, Sarver, PA (US)

(73) Assignee: PPG Industries Ohio, Inc., Cleveland, OH (US)

(21) Appl. No.: 19/570,661

(22) Filed: Mar. 18, 2026

Related U.S. Application Data
(60) Provisional application No. 63/775,380, filed on Mar. 21, 2025.

(51) Int. Cl. B05B 7/24; B05B 7/32; B05B 12/00; B05B 15/55

(52) U.S. Cl. CPC B05B 7/2486; B05B 7/32; B05B 12/006; B05B 15/55

(57) ABSTRACT

Provided herein is a spray applicator comprising a water spray assembly configured to spray an aqueous solution into a spray pattern produced by a spray nozzle comprising a mixture of two reactive components. A method of manufacturing a spray gun also is provided. A spraying system comprising the spray applicator and an apparatus configured to controllably deliver fluid from a first source and a second source to the spray applicator.

### CROSS REFERENCE TO RELATED APPLICATION

This application claims priority to U.S. Provisional Patent Application No. 63/775,380 filed Mar. 21, 2025, the disclosure of which is incorporated herein by reference in its entirety.

### FIELD

The disclosure relates generally to spray applicators and spray systems.

### BACKGROUND

Spray-applied foams, such as polyurethane and polyurea, are widely used in construction, insulation, industrial applications, and protective coatings.

### SUMMARY

A spray applicator is provided. The spray applicator comprises: (i) an applicator body extending from a first end comprising a handle portion to a second end; (ii) a first spray assembly, comprising (a) a fluid mixing chamber connected to or within the applicator body and configured to independently receive fluids from a first source and a second source, the fluid mixing chamber comprising a first fluid inlet and a second fluid inlet, a fluid mixing passageway, and a fluid outlet to receive mixed fluid from the fluid mixing passageway, and (b) a first spray nozzle structured and arranged to receive mixed fluid from the fluid outlet of the fluid mixing chamber, comprising a fluid inlet and a spray outlet positioned to direct a first liquid spray pattern external to the spray applicator; (iii) a second spray assembly comprising a fluid passageway and a second spray nozzle attached to the applicator body and positioned to direct a second liquid spray pattern into a first liquid spray pattern from the first nozzle; and (iv) a controller comprising an actuator mechanism and a trigger configured to control a flow rate of liquid from the first nozzle and/or from the second nozzle, wherein the trigger is located at or adjacent to the handle portion.

A spray system also is provided. The system comprises: (i) any of the spray applicators disclosed herein and (ii) an apparatus configured to controllably deliver fluid from the first source and the second source to the spray applicator.

A method of manufacturing a spray applicator also is provided. The method comprises affixing a water spray assembly to a plural component spray applicator comprising a plural component spray nozzle, wherein the water spray assembly comprises a water supply tube connected to a fluid input of a spray nozzle attached to the applicator body and positioned to direct a second liquid spray pattern into a first liquid spray pattern from the plural component spray nozzle of the plural component spray applicator.

### BRIEF DESCRIPTION OF THE DRAWINGS

FIGS. 1A and 1B provide schematic overviews of a spray system (FIG. 1A) and a spray applicator (FIG. 1B), as described herein.

FIGS. 2A-2D provide schematic cross sectional views of a spray applicator and elements thereof, as described herein.

FIG. 3 provides an isometric view of a spray system as described herein.

FIG. 4 provides a schematic view of mixing and spray elements of a portion of a spray applicator described herein.

FIG. 5 provides details regarding a computational fluid dynamics simulation as described below.

FIG. 6 provides a graph showing mixing of water and isocyanate spray streams at an intersect angle of 60° and at varying distances over time.

FIG. 7 provides a graph showing mixing of water and isocyanate spray streams at a spray distance of 10 mm at varying intersect angles over time.

### DETAILED DESCRIPTION

The technology described herein is illustrated by the drawings and technical description provided. Relative size, shapes, orientation, spatial configuration, and topology of various described and/or depicted elements, components, subsystems, or other structural aspects of the described systems are provided merely for convenience of illustration and description. Relative terms such as “above,” “below,” “distal,” and “proximal,” likewise are provided for convenience of illustration and description.

Spray applicators and spray applicator systems are provided that enable real-time control of foam density through controlled external water injection. The spray applicator may be a plural spray applicator that mixes and sprays the reactive components of two-component compositions. Reactive components, for convenience, may be referred to herein as “component A” and “component B”. The reactive components may react to form a foam. A plural spray applicator may include a first spray nozzle by which a mixture of component A and component B are sprayed, and a second spray nozzle that sprays water and directs the resultant spray into spray from the first nozzle. A plural spray applicator may comprise a mixing chamber and a single spray nozzle, where components A and B are separately fed into the mixing chamber and then the mixed reactive components are fed into the spray nozzle. Unless specified, “spray”, “spraying”, and the like includes sprays, mists, and/or aerosols, which may differ in terms of spray particle size and size distribution. By reference to “intersect”, “intersecting”, “directed into”, “directed towards”, or the like, in reference to the relative spray patterns of two spray streams, is meant that all or a portion of the spray stream patterns meet and mix together.

The water spray nozzle assembly may comprise an adjustable spray head capable of producing various spray patterns, such as aerosol, mist, spray, or stream, and/or spray particle sizes selected for different targets relating to the mixed reactive component such as foam density targets. A water spray control mechanism may be included in the system or on the spray applicator, and can comprise control components such as triggers, switches, valves, and/or pressure sensors and may include mechanical, electronic, pneumatic, electromechanical, and/or pneumomechanical (pneumatic-mechanical) components. The water spray control mechanism may allow an operator to adjust water flow rate relative to flow of the reactive components, enabling real-time modification of density of the mixed reactive components during application.

The water injection parameters, such as spray pattern, flow rate, and pressure, may be adjusted to modify the density of the resultant foam. Alternatively, the water spray may be turned off, allowing for spraying of a non-elastomeric reaction product.

Reactive components, e.g., component A and component B, react together upon mixing to produce a reaction product of components A and B. Components A and B and the ratio of components A and B may be selected based on the desired reaction product and desired mechanical properties, such as flexibility, thermal properties, and/or chemical properties thereof. Components A and B may be selected such that they are mixable and sprayable by the spray applicator described herein. In one example, component A may comprise an isocyanate (such as Rubinate® 9257, commercially available from Huntsman Corporation) and component B may comprise a polyol (such as RESTORA-PIPE 202, commercially available from PPG Industries, Inc.) that when reacted together, optionally in the presence of a catalyst, form a polyurethane reaction product. When the isocyanate and the polyol are reacted in the presence of water, the isocyanate reacts with the water, which acts as a blowing agent such that the resultant polyurethane reaction product is foamed, thus producing a polyurethane foam.

Component A and Component B may be preheated prior to mixing, such as to a temperature of at least 100° F., such as at least 110° F., such as at least 120° F. Component A and Component B may be preheated prior to mixing, such as to a temperature of no more than 300° C., such as no more than 250° F., such as no more than 200° F. Component A and Component B may be preheated prior to mixing, such as to a temperature of 100° F. to 300° F., such as 110° F. to 250° F., such as 120° F. to 200° F.

Component A and Component B may be sprayed at a pressure of at least 1000 psi, such as at least 1500 psi. Component A and Component B may be sprayed at a pressure of no more than 3000 psi, such as no more than 2000 psi. Component A and Component B may be sprayed at a pressure of 1000 psi to 3000 psi, such as 1500 psi to 2000 psi.

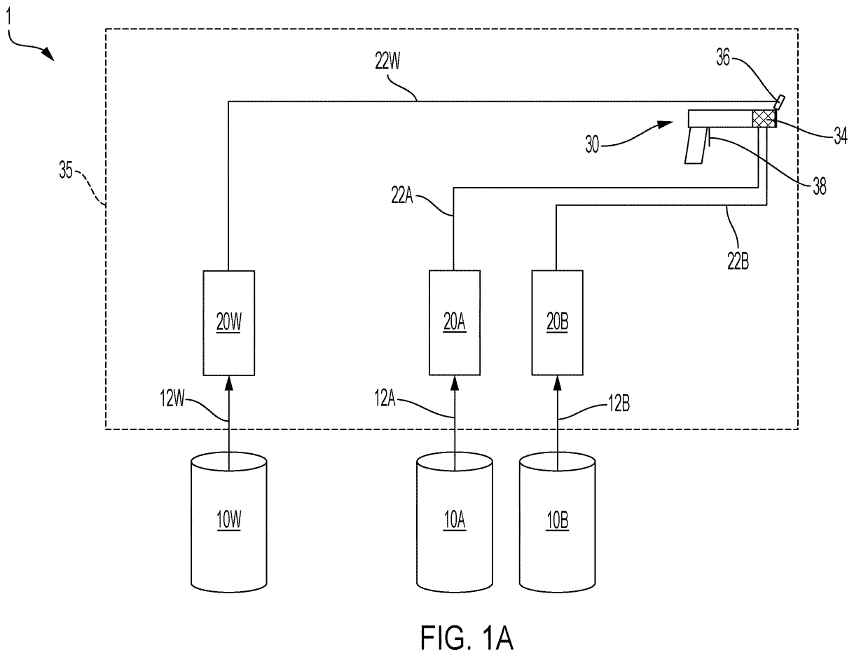

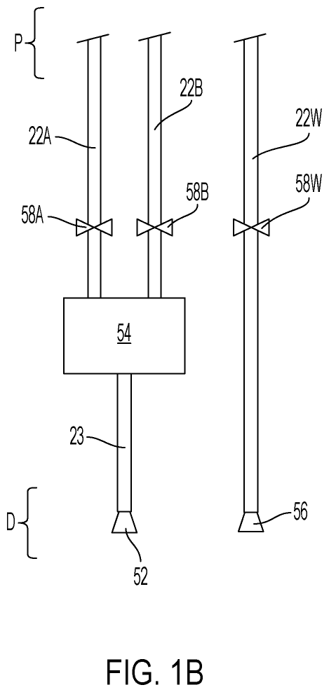

FIGS. 1A and 1B provide schematic overviews of the spray system and spray applicator described herein. For convenience, the terms “proximal” and “distal” are used and refer to orientation relative to an end user and the general flow of materials from component and water reservoirs (proximal) to the described spay nozzles (distal), as illustrated in FIG. 1B with proximal ends P and distal ends D of the depicted schematic assembly.

Referring to FIG. 1A, an exemplary system 1 is depicted schematically. Reservoirs may be buckets or any suitable vessel of any material compatible with storage or holding of the reactive components or water. A component A reservoir 10A, a component B reservoir 10B, and a water reservoir 10W are depicted. Letter suffixes “A”, “B”, and “W” are used throughout the figures to distinguish flow path components for component A, component B, and water, respectively. Liquid from component A reservoir 10A may be drawn through tube 12A, pressurized by pump 20A, and output through tube 22A to a spray applicator 30. Liquid from component B reservoir 10B may be drawn through tube 12B, pressurized by pump 20B, and output through tube 22B to spray applicator 30. Water from water reservoir 10W may be drawn through tube 12W, pressurized by pump 20W, and output through tube 22W to spray applicator 30. Component A and component B may be mixed and sprayed by a mixing and spraying assembly 34 included at a distal end of the spray applicator 30. Trigger 38 may actuate spray from spraying assembly 34. Water may be sprayed through water spray nozzle 36, which spray may be triggered by trigger 38, by a separate triggering mechanism, or may spray continuously. In use, release of component A, component B, and water may be controlled by any useful triggering mechanism, with a physical trigger 38 that mechanically actuates spray of the mixture of component A and component B being merely illustrative.

Controller 35 is depicted in phantom. Selection and control of any pumps, valves, sensors, and actuators in the system 1 by controller may be accomplished by any useful method. Electronic, computer-implemented, mechanical, electromechanical, pneumatic, or electropneumatic are examples of types of components and controllers that may be utilized. For example, mechanical valves, solenoids, servo-controlled, or other electro-mechanical valve types may be employed. The fluid streams of component A, component B, and water may be supplied under pressure to the spray applicator, or the spray applicator may be provided with a supplemental pressurization mechanism that pressurizes one or more of component A, component B, the water, and/or other component(s) at or within the spray applicator. Pressure of any or all of the fluid streams for component A, component B, and water may be adjusted manually by an end user by monitoring in-line pressure valves and control of power sent to each pump and/or flow of fluid through a valve being manually adjustable using suitable controls and/or purely mechanical valves. Pressure shutoffs may be included in-line for one or all of the components to shut off power to pumps and/or close solenoids or other electromechanical valves when pressure reaches a target level. One-way valves may be placed in-line to prevent component backflow. Alternatively, computer-implemented processes may be employed to monitor pressure via pressure sensors, and to control operation of any pumps and valves in the system to tailor flow rates through the spray applicator.

A “fluid passageway”, as described herein, may refer to a contiguous closed fluid path with a fluid inlet and a fluid outlet, such that fluid may flow through and is contained within the passageway from the fluid inlet to the fluid outlet. A passageway may comprise one or more branches or other features. The term “tube” or “tubes” may refer to any structure having an inlet, an outlet, and a fluid passage fluidly connecting the inlet and the outlet. As such, “tube” or “tubes” may refer to a closed fluid flow path, such as, for example, rigid tubes, flexible tubes, hoses, channels, and combinations of any of the preceding. Tubes may comprise one or more fluid paths, but may include branches, alternate or additional flow paths, or other features.

A spray applicator is shown in the various FIGS. as having a typical gun shape with a body portion, a handle portion, and a trigger, but may have any suitable configuration that is consistent with operation of the apparatus, for example the handle and body may be arranged linearly, as in a wand. The handle in either case may be contoured and sized for ease of grasping and spraying, with one or more triggers and any additional controls on the spray applicator being located conveniently to facilitate operation of the spray system and spray applicator. The spray applicator may have an overall gun shaped arrangement that may be employed for ease of use and consistency with current commercial spray guns. The body may be made of a plastic, a metal, a metal alloy, a ceramic, or any suitable material or combination of materials, and may include multiple parts.

Referring to FIG. 1B, a schematic diagram of an example of the general operation of a spray applicator 30 of FIG. 1A is provided. As indicated above, distal D and proximal P ends are shown for ease of description. In use, liquid may flow in a system from reservoirs at a proximal end to spray nozzles at a distal end of the spray applicator. Various components may be arranged in a proximal to distal sequence or vice versa, such as with pumps being distal to the reservoirs, the spray applicator being distal to the pumps, or the pumps being proximal to the spray applicator. As described in reference to FIG. 1A, component A, component B, and water may be pressurized and transferred to the spray applicator 30 via tubes 22A, 22B, and 22W, respectively. Component A and component B enter inlets of mixing chamber 54 via distal ends of tubes 22A and 22B respectively, where they are mixed and then output to a first spray nozzle 52 via fluid conduit 23, which may be a tube or a connector between the mixing chamber 54 and the first spray nozzle 52. Water may be pumped through tube 22W to the water spray nozzle 56. A trigger in the spray applicator may control valves 58A and 58B to control flow of component A and component B into the mixing chamber 54 and therefore spray output from the first spray nozzle 52. The same trigger that controls valves 58A and 58B may also control valve 58W, such that operation of the trigger controls spray output from both the first spray nozzle 52 and the water spray nozzle 56. A separate trigger or an electronic switch or dial may be used to control valve 58W and therefore water flow through the water spray nozzle 36. In one example, water flow to water spray nozzle 36 is controlled proximal to the spray applicator 30, such as by adjusting a pump and/or a valve external and proximal to the spray applicator 30.

Referring further to FIG. 1B, the mixing chamber 54 need not be located within the body of a spray applicator, but may be located externally, such that the spray applicator includes only fluid conduit 23, which may comprise a tube portion external to the spray applicator, an input connector on the spray applicator and a tube or other channel between the input connector and the first spray nozzle 52, and may also comprise an in-line valve actuated by a trigger of the spray applicator such as the same trigger configured to control flow through the first spray nozzle 52. The reactive components may be pre-mixed in a reservoir obviating the need for a mixing chamber. Where the reactive components are mixed before they pass through the spray applicator, they may be selected to have a sufficiently long pot life before the mixed composition becomes too viscous to be sprayed and flushed from the system. As such, mixing components in the spray applicator immediately before spraying may improve spraying, purging, cleanup, and maintenance.

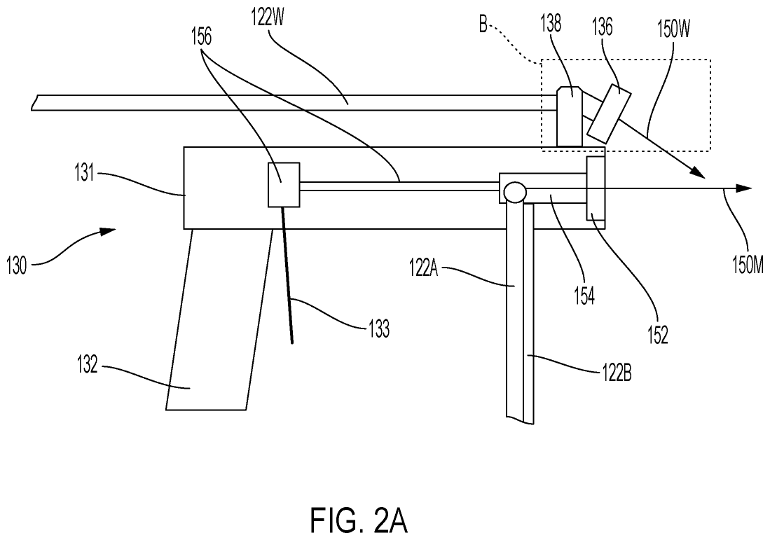

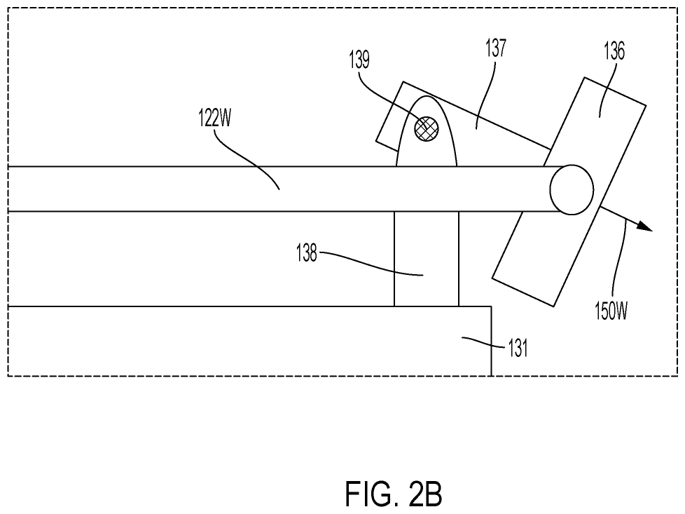

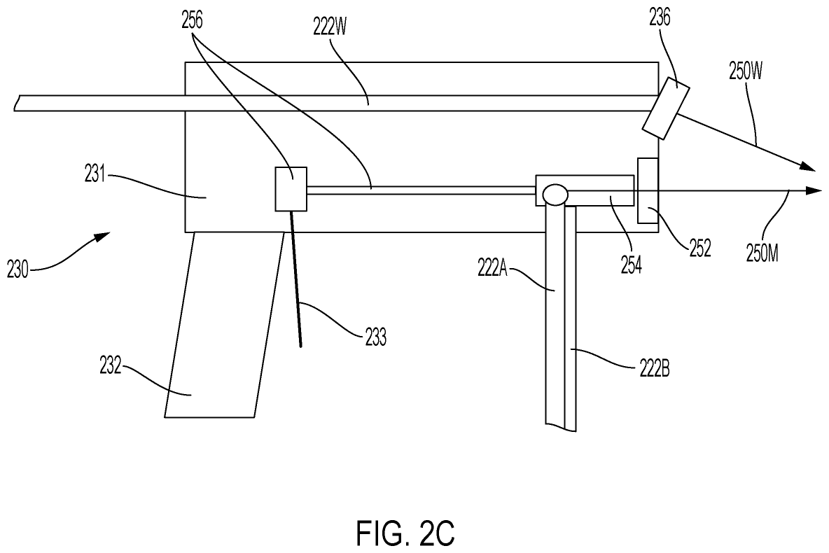

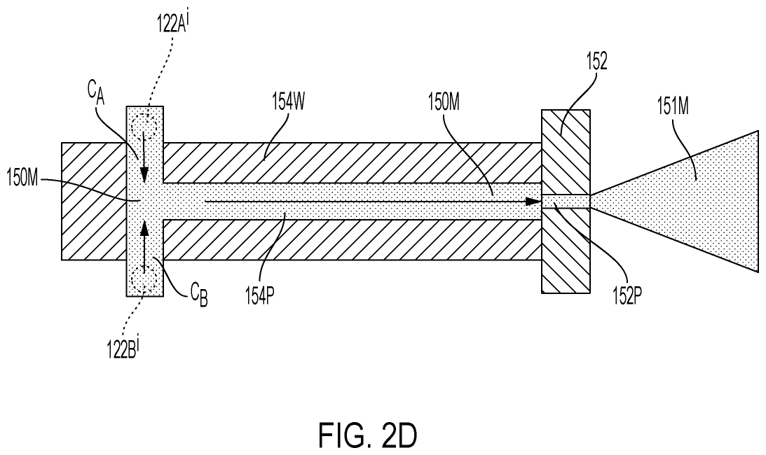

FIGS. 2A-2C schematically depict cross-sections of two versions of the spray applicator 130 and 230 in which the water spray assembly is attached externally to the apparatus (FIG. 2A) or is contained within a body of the spray applicator (FIG. 2C). Referring to FIG. 2A, tube 122A, tube 122B, and tube 122W supply component A, component B, and water, respectively, to spray applicator 130. Spray applicator 130 comprises a housing body 131, a handle 132 and a trigger 133. Component A and Component B flow into mixing chamber 154 and from first spray nozzle 152, producing spray of a mixture of component A and component B with a first spray direction 150M (mixed). Water flows from tube 122W into water spray head 136, producing a spray of water with a second spray direction 150W. Spray directions 150M and 150W refer to the general direction of the spray pattern output of the sprays. Spray directions 150M and 150W are configured such that the water spray stream and the component mixture spray stream mix. Flow of component A and component B into the mixing chamber 154 is actuated by trigger 133 in combination with actuator 156. Details of the actuator 156 and its mechanism of operation are not shown and can be any suitable mechanism. Control of spray from the spray applicator may be binary (on/off), or may be variable, increasing with the distance the trigger is pulled. The controller may comprise a variable pressure controller actuated by the trigger 133 such that the trigger may operate in a binary fashion, but the spray may be controlled by setting a pressure value for the variable pressure controller, which in turn controls the degree of opening of a valve, pump speed, pressure and/or other set parameter that controls flow of reactive components into the mixing chamber. A purge mechanism may be incorporated into the spray applicator to expel fluids or reacted components from the mixing chamber 154 and/or the first spray nozzle 152, for example using compressed air in a pneumatic system. Control of the actuator may be pneumatic and/or electronic. Examples of suitable actuator mechanisms, including a purge mechanism and a cartridge-based mixing chamber and spray head are described, such as with respect to the cartridge-based systems depicted in International Patent Publication No. WO 2020/086980, pages 4-32, and WO 2021/081342, pages 2-17, the cited portions of which are incorporated herein by reference. Bracket 138 attaches the water spray head 136 to the body 131. A clip or additional bracket (not shown) configured to retain the tube 122W also may be attached to the body 131 of the spray applicator proximal to the bracket assembly, such as at an end of the body 131 opposite the spray head 152. United States Patent Publication No. 2020/0338578, paragraphs [0029] to [0061], describes an exemplary pneumatic spray device and describing general operation of pneumatic spray devices and are incorporated herein by reference. Water spray may be controlled independently from control of spray of the mixed components.

FIG. 2B shows an enlarged portion of the spray applicator 130 at B in FIG. 2A with tube 122W, body 131, water spray head 136, and bracket 138. Also depicted are water spray head adaptor 137 connecting tube 122W to water spray head 136, which is retained in bracket 138 by retainers 139, which may be pins, screws, or the like. The retainers 139 may be welded or soldered in a fixed position in the bracket 138 or permit rotation of the spray head within the bracket 138 and the ability to change the angle at which water spray, as indicated by spray vector 150W, impinges on spray from the first spray head 132. Alternatively, water spray head adapter 137 may be welded into place at a fixed position in bracket 138, such that depicted retainers 139 comprise weld joints. Other methods of retaining the water spray head 136 in the bracket and/or onto a surface of the body 131 may be employed, such as friction fittings, as are known in the art.

A commercial plural component spray applicator, such as a Graco AP Spray Gun, may be retrofitted with a water spray assembly as shown in FIGS. 2A and 2B, in which bracket 138 is welded, soldered, clamped, retained, or otherwise affixed to a body of a plural spray applicator. Avoiding disruption of operation and maintenance of the commercial spray applicator may dictate the size, shape, placement, and configuration of the bracket 138 on the body 131 of the spray applicator. For example, when a plural spray applicator comprises a removable cartridge comprising all or part of the reactant component mixing and spray assembly, the bracket may be welded, clipped, or otherwise attached to the spray applicator body behind the attachment point of the cartridge to the spray applicator body, depending on the overall structure and operation of the plural spray applicator.

FIG. 2C schematically depicts a cross section of a spray applicator 230 as described in reference to FIG. 2A. Tube 222A, tube 222B, tube 222W, handle 232, trigger 233, water spray head 236, first spray head 252, mixing chamber 254, and actuator 256 are essentially as described in reference to FIG. 1A. In FIG. 2C, the body 131 is configured to retain a distal portion of the tube 222W and the water spray head 236, with internal brackets or structures to retain the water spray head 236 either in a fixed position to intersect spray from the first spray head 252, or in an end user-movable position in which the angle of spray from the water spray head 236 can be adjusted by the end user to change the angle of intersect with spray from the first spray head 252.

A mixing chamber may be a static or an active device comprising active stirrers, impellers, or the like. Given the size and reliability needed for a mixing chamber incorporated into the spray apparatus and system described herein, the mixing chamber may be static. FIG. 2D depicts schematically a type of static mixing chamber. A mixing chamber 154 and a first spray nozzle 152 as in FIG. 2A, are depicted. Mixing chamber 154, may comprise an input for component A 122A′, an input for component B 1221 and a fluid passageway 154P that may be generally “T” shaped, but may be configured in any useful shape to encourage mixing and to facilitate control of flow through the passageway. First spray nozzle 152 may comprise a fluid passageway 152P. Structural or internal surface features of the passageways 154P and 152P, that may control flow and spray characteristics, such as mixing, flow rates, flow patterns, spray pattern, spray particle size, and spray velocity are not shown. Structural or internal surface features of the passageway 154P may comprise ridges, vanes, helical elements, diameter changes, and/or other protuberances that may encourage mixing of components A and B while supporting adequate flow rates and ease of cleaning and maintenance.

Referring again to FIG. 2D, in use, component A (C_{A}) may enter the passageway 154P via input 122A′ and component B (C_{B}) may enter the passageway 154P via input 1221. Components C_{A} and C_{B} may be mixed within passageway 154P forming mixed reactive component stream 150M. Arrows depict the direction of flow of components C_{A} and C_{B} and mixed reactive component stream 150M. Mixed reactive component stream 150M may pass through the passageway 152P of the first spray nozzle 152 to produce spray pattern 151M.

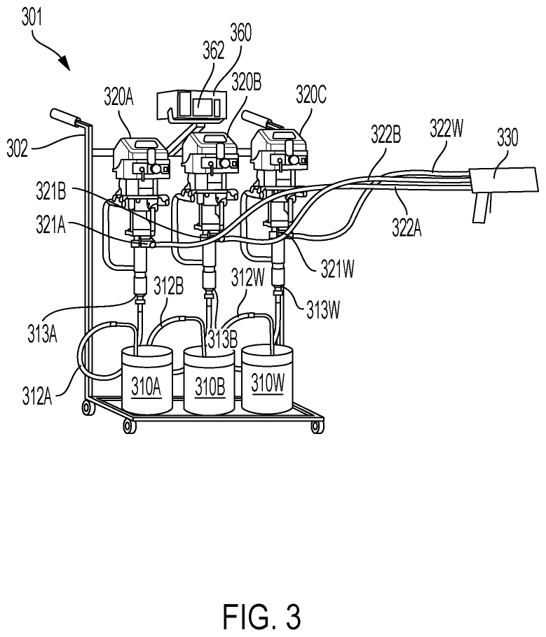

FIG. 3 depicts an exemplary spraying system 301 incorporating the spray applicator depicted in the schematic diagrams of FIGS. 1A and 1B. Details unnecessary for understanding the present disclosure are omitted for clarity. The spraying system may be mounted on a cart 302, allowing for easy movement of the system 301 in a spraying facility by an end-user. FIG. 3 depicts reservoirs 310A, 310B and 310W for component A, component B, and water, respectively. Tubes 312A, 312B, and 312W are placed in reservoirs 310A, 310B, and 310W and connect to inlets 313A, 313B, and 313C of pumps 320A, 320B, and 320W, respectively. Outlets, 321A, 321B, and 321C for pumps 320A, 320B, and 320W, respectively, are depicted. Tubes 322A, 322B, and 322W are connected to outlets, 321A, 321B, and 321C, respectively, and feed into spray applicator 330. A computer implemented control unit 360 comprising a user interface 362 is depicted. User interface 362 may comprise a display and input devices for controlling various aspects of the system 301. Parameters and actions of the system may be measured and/or implemented based on sensor or user input either at the control unit 360, at the spray applicator 330, or otherwise connected to the control unit 360, for example by remote switches. Examples of system parameters may include pump speed, line pressure, reservoir fluid levels, reservoir volume, temperature, and/or flow rates in the tubes or spray applicator. Parameter values may be set by an end user at the user interface 262. Control unit 360 can receive input from various sensors, such as one or more flow sensors, pressure sensors, temperature sensors and/or fluid level sensors and/or from user-activated triggers, switches, or other input devices. Action of the spray applicator 330 may be controlled by electromechanical devices, such as valves, solenoids, switches, sensors, and the like. Alternatively, action of the spray applicator 330 may be mechanically controlled and implemented, and/or pneumatically controlled and implemented, by a separate compressed air supply and feed tubes (not shown) connected to the spray applicator 320 that may be optionally mounted on the cart 302.

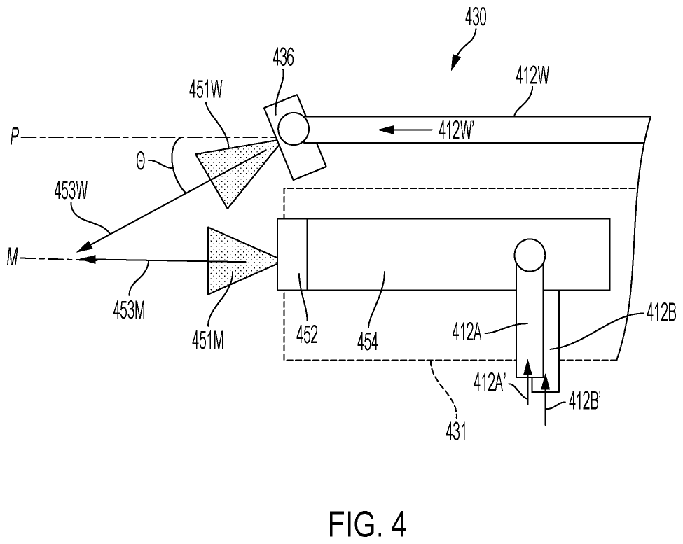

FIG. 4 depicts a schematic cross section of a distal portion of an exemplary spray applicator 430 as described herein. Body 431 of spray applicator 430 is shown in phantom. Tubes 421A and 412B are fluidly connected to mixing chamber 454, and to first spray head 452. Component A 412A′ passes through tube 412A into mixing chamber 454 and component B 412B′ passes through tube 412B into mixing chamber where components A and B are mixed and may be output as a first spray pattern 451M in a spray pattern direction 453M through first spray nozzle 452. Tube 412W is fluidly connected to water spray head 436. Water 412W′ passes through tube 412W and may be output as a water spray pattern 451W in a spray pattern direction 453W through water spray nozzle 436.

The mixed materials spray pattern and the water spray pattern spray in the directions 453M and 453W, respectively. While spray pattern directions 453M and 453W may be parallel, in the context of the present disclosure where P (dotted line) is parallel to M (dotted line corresponding to direction 435M), spray patterns 451W and 451M may intersect such that spray pattern direction 453W is angled towards spray pattern direction 451M at angle θ with respect to P.

For the spray applicator described herein, θ may be greater than 0°, greater than 1°, greater than 2°, greater than 3°, greater than 4°, or at least 5°. θ may be no more than 90°, no more than 60°, no more than 30°, or no more than 15°. 0 may be 1° to 90°, 1° to 60°, 1° to 30°, 5° to 90°, 5° to 60°, 7° to 60°, 10° to 60°, 15° to 45°, or any increment therebetween, such as 5°, 7°, 10°, 15°, 20°, 30°, 45°, or 60°. The spray patterns may intersect at a distance of 1 inch to 6 inches from the first spray nozzle. By the force of injection of water into the reactive components, along with the effect of gravity, the combined spray output may deflect to some degree, which may be affected or selected by the respective mass and velocity of the water and reactive components. Placement of the water spray nozzle with respect to the mixed component nozzle, the angle of spray from the water spray nozzle, and other spray parameters may be accounted for when determining an optimal angle θ for the water spray nozzle.

The spray applicator 430 may be configured to permanently establish a selected angle, wherein one or both of the first spray nozzle 452 and water spray nozzle 436 can be angled with respect to the other. However, mechanisms can be provided to allow for angular adjustment of one or both of the first spray nozzle 452 and water spray nozzle 436 to select the point of intersection of the flows of the mixed components and water. While a single water spray nozzle 436 is shown, the spray applicator 430 can include additional water spray nozzles to either “steer” the combined material flow and/or to alter the resulting foam properties.

Upon intersection of the mixed material spray pattern and the water spray pattern, a foam with a selected density may form.

Distance between the spray outlets of the spray nozzles 436 and 452 may vary depending on the range of the overall flow rate of the mixed reactive components from the device.

The water flow rate may be at least 0.1% of the flow rate of the mixed components, such as at least 0.5%, such as at least 1%. The water flow rate may be no more than 5% of the flow rate of the mixed components, such as no more than 4%, such as no more than 3%. The water flow rate may be 0.1% to 5% of the flow rate of the mixed components, such as 0.5% to 4%, such as 1% to 3%. Spray parameters, such as flow rate, line pressure, spray patterns, spray droplet size, distance between spray nozzles, and angle of intersection of the spray patterns may be optimized for any given combination of spray systems and spray applicators, such as choice of spray nozzles and reactive components and implementation of a system controller.

Reference is made herein to water being transferred and sprayed. Unless specified expressly, the water can be an aqueous solution, suspension, or colloid comprising one or more additional ingredients, such as salts, surfactants, stabilizers, catalysts, colorants, rheology modifiers, or any other water soluble or waterborne constituent(s) compatible with the devices and systems described herein and reaction of reactive components. As used herein, “colorants” refers to any substance that imparts a color and/or other opacity and/or other visual effect to the composition.

The described spray applicator may include one or more additional water spray nozzles to introduce more than one stream of water into the mixed reactive component (mixed component) spray pattern. Likewise, the described spray applicator may include one or more additional mixed component spray nozzles to introduce more than one stream of the mixed components. While the device and system illustrated in the FIGS. shows an angled water spray pattern and a mixed component pattern parallel to a body of the spray applicator, the mixed component spray pattern may be angled with respect to the body of the spray applicator.

A variation of the system depicted in the FIGS. may be implemented in a manufacturing setting, such as on an assembly line, and may include suitable computer-implemented control elements, sensor elements, and robotic elements selected and configured to control motion of the spray applicator, flow of reactive components, flow of water, system pressures, spray patterns, angle of intersect of spray of water with spray of the mixture of reactive components, and any other parameter useful in applying the spray on an article in an automated fashion.

Spray nozzles for water are broadly available and may be selected for spray pattern, particle size, flow rate, size, shape, weight, materials, durability, or any other feature pertinent to its use in the spray applicator as described herein.

### EXAMPLES

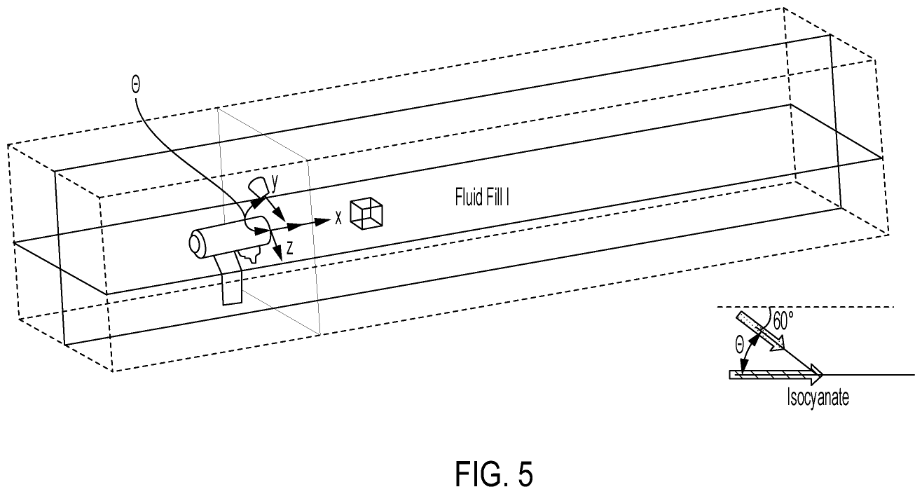

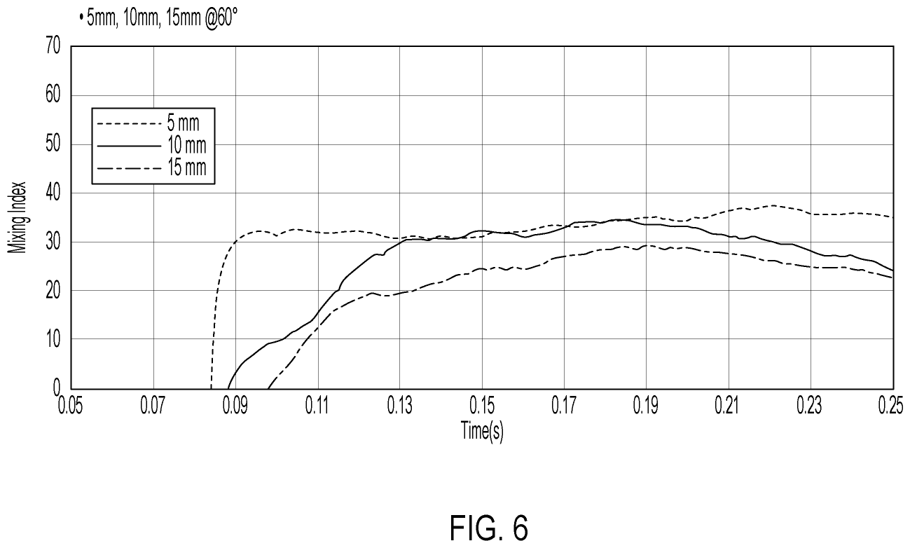

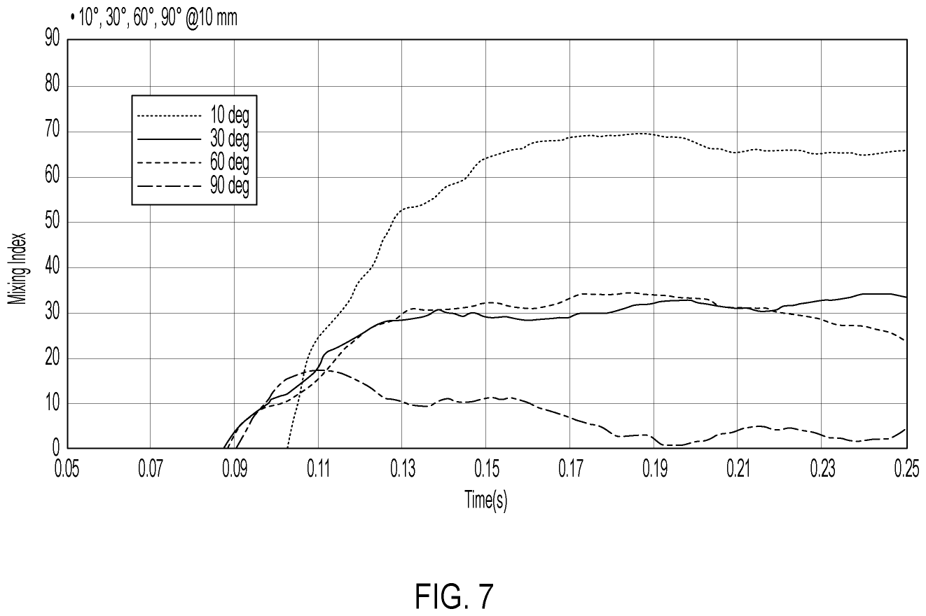

Additional details regarding material flow rates, vertical distance between fluid flows, and angle of intersection are shown in FIG. 5, FIG. 6, and FIG. 7 which provide data from a computational fluid dynamics (CFD) model including geometry model buildup, physical domain discretization, physical and numerical methodology implementation, and data visualization.

FIG. 5 outlines the assays described herein, providing drawing of a modeled virtual spray gun for a CFD simulation. Isocyanate was provided at a flow rate of 0.5 gallons per minute. Water flow rate was 1.25% of the rate of the isocyanate (0.00625 gallons per minute). Water was injected from spray head 632 as stream 633 into the isocyanate stream 631 from spray gun 630 at various distances and angles of intersection (θ). The water and isocyanate were mixed at a vertical separation d of 5 mm, 10 mm, and 15 mm, with an angle of water spray intersection “θ” at 10, 30, 60 and 90 degrees at 10 mm vertical separation.

FIG. 6 shows computation fluid dynamic results controlling for angle of intersection, wherein the water stream is directed at the isocyanate stream at 5 mm, 10 mm, and 15 mm of vertical separation with θ fixed at 60°. The vertical axis of the graph shows a mixing index value representing the mixing progress, and the horizontal axis shows a time value representing seconds.

This is a virtual CFD model. It is noted that the mixing index value is a nondimensionalized mathematic definition of mixing progress. The definition involves the standard deviation of massless tracers and mean averaged tracer concentration within a controlled volume. Time is represented in the CFD model as seconds. The viscosity of the isocyanate stream was based on a commercial polyurea product. In the present example, a mixing value of 20 or greater or of at least 50 may be selected for commercial use.

FIG. 7 shows a test result that controls distance and varies the angle of intersection, wherein the stream is directed at the isocyanate stream at 10°, 30°, 60°, and 90° for θ at 10 mm of vertical separation.

These results indicate that at the same angle (60°), a shorter vertical distance between streams leads to a more rapid mixing of the water and isocyanate spray streams. Further, with the same distance between streams, decreasing the angle of intersection can result in better mixing performance. For example, at the described relative flow rates for water and isocyanate, when the angle of intersection is changed from 30° to 10° at a 10 mm vertical separation, the mixing value increases more than two-fold. The highest mixing values observed in the described model with an isocyanate flow rate of 0.5 gallons per minute and a water flow rate of 0.00625 gallons per minute were at a 10 mm vertical separation and a 10° angle of intersection.

Based on the examples above, it is expected that (i) the flow rate of water may be 0.1% to 5% of the flow rate of the isocyanate, (ii) the separation between the water and isocyanate streams may be 5 mm to 15 mm, and (iii) the angle “θ” between the streams can be 10° to 30° with trends indicating that angles less than 10° are expected to produce good mixing.

Four tests (A-D) were conducted using a commercially available isocyanate and polyol products at various water flow rates to demonstrate density control capabilities. In brief, to a Graco HPE10 machine, two gallons of Rubinate® 9257 and RESTORA-PIPE 202 B-side, were charged into the A-side and B-side tanks, respectively. The machine was powered on, and each material was recycled through the hosing unit in separate tubes and preheated until a batch temperature of 150° F. was obtained. An air purge gun (AP Fusion) was installed to the hosing unit, and the spray pressure was set to 1700 psi. The gun trigger was squeezed to mix the material and spray the product to produce a polyurethane rigid foam to provide impact resistance. The spraying time was reduced to let the exotherm to dissipate until the temperature was near ambient temperature, around 100° F. The final thickness of this coat was 50 mils.

To form the structural foam, silicone stabilizer and amine catalyst were mixed with water as indicated in Table 1. A-side and B-side were mixed inside the spray gun's mixing chamber and sprayed through the gun, and the aqueous solution of Table 1 was sprayed into the stream of the mixed A side and B-side at a 7° angle. The angle and the amount of this stream into the A and B stream can be modified to produce different characteristics of the resulting foam.

TABLE 1

| | RS-202 + | | | | |
|---|---|---|---|---|---|
| | 0.5% Bi | | | | |
| | catalyst | A | B | C | D |
| Aqueous solution | — | 0.3 | 0.75 | 1 | 1.35 |
| (% by weight of | | | | | |
| B-side) | | | | | |
| Foam Density | 74 | 30 | 15 | 12.5 | 10 |
| (lbs/ft³) | | | | | |

Foam density measurement is according to ASTM D3574. As shown in the table, increasing the aqueous solution content results in a significant reduction in foam density, with values ranging from 30 lbs/ft³ at 0.3% aqueous content to 10 lbs/ft³ at 1.35% aqueous content.

Beyond density control, the system can be used for other applications. For example, the water injection stream may include surfactants to influence foam cell structure. Also, pigments may be added to the water stream, allowing for color addition to the reactive components without flushing or changing the primary components of the spray applicator. The system allows switching between non-foamed elastomer and foamed elastomer applications using the same spray applicator by simply activating or deactivating the water injection system. This provides significant cost savings by eliminating the need for multiple pieces of application equipment to achieve different foam densities.

For purposes of the detailed description, it is to be understood that the disclosure may assume various alternative variations and step sequences, except where expressly specified to the contrary. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect basic and novel characteristic(s)”.

Whereas specific details have been described, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure, which is to be given the full breadth of the claims appended and any and all equivalents thereof.

1. A spray applicator, comprising:
an applicator body extending from a first end comprising a handle portion to a second end;
a first spray assembly, comprising:
a fluid mixing chamber connected to or within the applicator body and configured to independently receive fluids from a first source and a second source, the fluid mixing chamber comprising a first fluid inlet and a second fluid inlet, a fluid mixing passageway, and a fluid outlet to receive mixed fluid from the fluid mixing passageway; and
a first spray nozzle structured and arranged to receive mixed fluid from the fluid outlet of the fluid mixing chamber, comprising a fluid inlet and a spray outlet positioned to direct a first liquid spray pattern external to the spray applicator;
a second spray assembly comprising a fluid passageway and a second spray nozzle attached to the applicator body and positioned to direct a second liquid spray pattern into a first liquid spray pattern from the first nozzle; and
a controller comprising an actuator mechanism and a trigger configured to control a flow rate of liquid from the first nozzle and/or from the second nozzle, wherein the trigger is located at or adjacent to the handle portion.

2. The spray applicator of claim 1, wherein the second spray nozzle is mounted on the applicator body.

3. The spray applicator of claim 1, wherein the fluid mixing chamber and the fluid passageway of the second spray assembly are contained within the applicator body.

4. The spray applicator of claim 1, wherein the first spray nozzle is mounted in a removable cartridge.

5. The spray applicator of claim 4, wherein the second spray nozzle is integral with the removable cartridge.

6. The spray applicator of claim 1, wherein an angle at which the first liquid spray pattern and the second liquid spray pattern intersect is 1° to 60°.

7. The spray applicator of claim 6, further comprising a first variable angle mount attached to the second spray nozzle and/or a second variable angle mount attached to the first spray nozzle that controls the angle at which the first liquid spray pattern and the second liquid spray pattern intersect.

8. The spray applicator of claim 6 wherein the first spray nozzle and the second spray nozzle are mounted at a fixed angle at which the first liquid spray pattern and the second liquid spray pattern intersect.

9. The spray applicator of claim 1, further comprising a compressed air input and wherein the controller is pneumatic.

10. The spray applicator of claim 9, further comprising a pneumatic purge mechanism configured to purge liquid within the mixing chamber and/or the first spray nozzle.

11. A spray system, comprising:
the spray applicator of claim 1; and
an apparatus configured to controllably deliver fluid from the first source and the second source to the spray applicator.

12. The system of claim 11, wherein the apparatus configured to controllably deliver fluid from the two sources to the spray applicator comprises two pumps independently connected to the two sources and to fluid inputs of the spray applicator and configured to draw liquid from the two sources and to deliver pressurized liquid from the two sources to the mixing chamber.

13. The system of claim 12, further comprising a pump configured to draw water from a water source and to deliver pressurized water to the second spray nozzle.

14. The system of claim 13, comprising a water reservoir configured to supply an aqueous solution to the second spray nozzle.

15. The system of claim 14, wherein the water reservoir comprises water or an aqueous solution comprising a salt, a surfactant, a stabilizer, a catalyst, a colorant, and/or a rheology modifier.

16. The system of claim 13, further comprising:
a computer implemented control unit configured to monitor and/or to control a system parameter and comprising a user interface configured to provide a user with monitored system parameter information and to provide user control of one or more system parameter; and
a flow sensor configured to obtain fluid pressure and/or fluid flow rate information for fluid entering the mixing chamber, the first spray nozzle, and/or the second spray nozzle,
wherein a system parameter comprises one or more of fluid pressure, fluid flow rate, pump speed, fluid temperature, reservoir fluid level, reservoir volume, air pressure of a pneumatic device, and/or a user set point for one or more of fluid pressure, fluid flow rate, pump speed, fluid temperature, air pressure of a pneumatic device, reservoir volume, and/or fluid levels for a reservoir.

17. The system of claim 11, further comprising a first reservoir and a second reservoir configured to independently supply fluid to the fluid inlets of the mixing chamber.

18. The system of claim 17, wherein the first reservoir comprises a first reactive component of a two-part reaction mixture, and the second reservoir comprises a second reactive component of the two-part reaction mixture.

19. The system of claim 18, wherein the first reactive component of the two-part reaction mixture comprises an isocyanate and the second reactive component of the two-part reaction mixture comprises a polyol.

20. A method of manufacturing a spray applicator, comprising affixing a water spray assembly to a plural component spray gun comprising a plural component spray nozzle, wherein the water spray assembly comprises a water supply tube connected to a fluid input of a spray nozzle attached to the applicator body and positioned to direct a second liquid spray pattern into a first liquid spray pattern from the plural component spray nozzle of the plural component spray gun.
